(19) United States
(12) Patent Application Publication
(10) Pub. No.: US 2009/0197652 A1
(43) Pub. Date: Aug. 6, 2009

(54) Integrated Portable WAN Module In Computer

(76) Inventors: Olof Lundstrom, Stockholm (SE); Mikael Lundman, Sollentuna (SE)

Correspondence Address: ERICSSON INC., 6300 LEGACY DRIVE, M/S EVR 1-C-11, PLANO, TX, 75024, US

(21) Appl. No.: 12/089,638

(22) PCT Filed: Oct. 10, 2005
(86) PCT No.: PCT/SE2005/001497

§ 371 Date: Aug. 22, 2008

(51) Int. Cl. H04M 1/00

(52) U.S. Cl. 455/574

(57) ABSTRACT

The invention relates to an integrated portable computer (1) and WAN module (12). The WAN module comprises a cell phone platform provided with a plurality of functional modules (21-34). The WAN module is connected to a battery (41) of the portable computer so as to supply power to the WAN module and allow operation of the functional modules while the portable is in operating mode as well as while the portable computer is in sleeping mode. A casing (13, 14) of the portable computer is provided with an extra display (20) allowing notification and also presentation of a received instant message while the computer is in sleeping mode. The casing (13, 14) of the computer is provided with a plurality of antennas (17-19). Examples of functional modules are a push mail module (25), an IMS module (33), a streaming media module (27), a security module (30) and a generic IP handler module (32).

### TECHNICAL FIELD OF THE INVENTION

The invention relates generally to the field of portable computers and radio access to wide area networks (WAN). In particular the invention relates to a to an integrated WAN module in a portable computer.

### DESCRIPTION OF RELATED ART

A cell phone of to-day comes with many peripheral units, such as FM radio, a small display, and an audio module. Today's personal computers (PC) such as portable computers, lap-top computers and desktop computers, have no default radio access to a network. In other words they have no default mobile access. If a mobile access is desired the user has to install a PC card, exemplary a PCMCIA card (Personal Computer Memory Card Industry Association), or a handset in the computer. A handset is typically a mobile cell telephone temporarily connected to a PC and used as a dial up modem. Typically a PC card offers access to a local area network (LAN) or an intranet. Via the LAN or the intranet the PC has access to Internet thus making the services of Internet, or other networks connected thereto, available to a mobile user of the portable computer.

A limitation of today's portable computers is that the battery capacity is limited. Typically mobile operation of the portable computer is limited to some few hours.

Another limitation is that a portable computer provided with a PC card will loose its access to the LAN when the computer is switched off. The same will happen when the battery is depleted after some few hours operation of the computer.

A PC card installed in a portable computer is always a slave unit to the computer which is a limitation. The PC card provides the portable computer with a mobile access, nothing more; it does not enhance the operation as such of the portable computer. When the computer is powered off the connection to the LAN is lost. This means that the user can only use the services of the LAN, Internet and other networks connected to Internet when the portable computer is on which is a limitation. In particular the ability to instantly get information from the LAN or from the Internet of an event that the users would like to know is lost. Exemplary the user cannot receive information that he/she has received an e-mail or instant message such as SMS (short message service), MMS (multi media service), VoIP (voice over IP) call and similar.

In other words today's solution to the problem of providing a mobile access to a portable computer requires the computer be on. Is the computer in sleeping mode, popularly also referred to as energy saving mode, the user will receive no notification of an incoming instant message or VoIP/telephony call.

A device that provides an always on connection to the Internet is known from US 2004/0047344 A1. The device is connected to a stationary PC, uses low power components, has a processor of its own, and acts as a hub for all the network and peripheral connections of the PC. The device can run applications of its own and is able to get notifications of incoming e-mails or e.g. VoIP calls and alert the PC user of the receipt while the PC is off. The device has a display of its own.

A product sheet entitled RTL8180L published at Internet 2005-08-18 on the address www.realtek.com/products relates to wireless LAN ICs. The IC supports remote wake-up using Microsoft wake-up frames. The IC is used with LANS and does not support mobile access.

A main drawback adhering the device according to said US patent is that it is stationary and cannot provide a mobile access. Neither has it any means by which a WAN access is made. Still another drawback is that it cannot make use of functions already present in a WAN, such as a wake-up function for wake-up the PC from its sleeping mode.

### SUMMARY OF THE INVENTION

The present invention strive to reduce the drawbacks described above. The problem solved by the invention may be formulated: how to provide a mobile access in a portable computer and improve the functionality of a portable computer.

This is achieved with WAN module integrated with a portable computer in accordance with claim 1.

The WAN module takes its power from the battery of the portable computer, provides an always-on connection to a WAN and enhances the operation of the portable computer by interworking with it. A multitude of functionalities provided by the network layer of the WAN network are available to the WAN module and also to the portable computer. In other words, the WAN module is a smart unit that makes the portable computer work significantly better compared to an ordinary portable computer. For example the WAN module receives notification of an e-mail to the user when the e-mail is stored an server in a network to which the WAN is connected. The WAN, that is the network, can use push technique to notify the WAN module of the e-mail or can send a notification in the form of an SMS to the WAN module. By providing the portable unit with an extra display driven by the WAN module notification of an incoming e-mail can be visually shown to the user on the extra display if the portable computer is in its sleeping mode.

The WAN module is a modified cell phone platform built by low power components, it is powered by the battery of the portable computer, and allows an always-on communication with a WAN. Typically, if the battery capacity of the portable computer allows computer operation in the order of some hours, say about 3 hours, the WAN module integrated with the portable computer and powered by the portable's battery can provide a mobile WAN access for more than 100 hours. This is so because the battery of the portable computer is powerful, more powerful than for example the battery of a conventional cell phone.

The reason why the battery life of a portable computer is low is that its processor and other hardware in combination with its advanced applications consume more power than does a cell phone provided with a small display and low power components.

Since the WAN module can perform certain tasks without utilizing the computer, it will also improve the operational time of the computer. The WAN module has an operational time that is several times that of conventional cell phone platforms, such as for example Ericsson's models U100, U250, U300, and U350.

By continuously listening to the control signalling in the WAN network the WAN module can use page signalling information in order to wakes up the portable computer if it is in its sleeping mode and actions need to be taken on the portable.

With the invention a user can have an always on connection to the radio based WAN network giving the user a superior service since the user is acknowledged in case of an event the user should know about, e.g. the event of an incoming email message or VoIP call.

Examples of applications that reside in the WAN module and can be run without involving the portable computer, that is when the portable computer is off, is a music player allowing the user to listen to music. For example, to-day it is possible to listen to music and speech over a cell phone. The same can be done with the WAN module and to achieve this all that is required is to provide a piece of software. The required software is the WAN module's music player. The WAN module can perform graphics work on the portable computer's extra display. The WAN module may use the extra display to show status of the radio connection to the WAN network.

By providing antenna systems in the portable computer the sensitivity of the receiver in the WAN module is improved. This implies improved QoS at the user end and allows use of higher bit-rates, which increases the performance of the WAN as seen from the network operator's point of view. Three dimensional (3D) antenna systems may be provided in the portable computer which further improves the QoS and the use of higher bit-rates.

### BRIEF DESCRIPTION OF THE DRAWINGS

FIG. 1 is a net view illustrating the environment in which the invention is used,

FIG. 2 is a front view perspective view of a portable computer in accordance with the invention,

FIG. 3 is a back view perspective view of a portable computer in accordance with the invention

FIG. 4 is a top view of a motherboard with integrated WAN module in accordance with the invention,

FIG. 5 is a simplified block diagram of a WAN module in accordance with the invention, and

FIG. 6 is a schematic net view illustrating reception of a push mail.

### DETAILED DESCRIPTION OF EMBODIMENTS

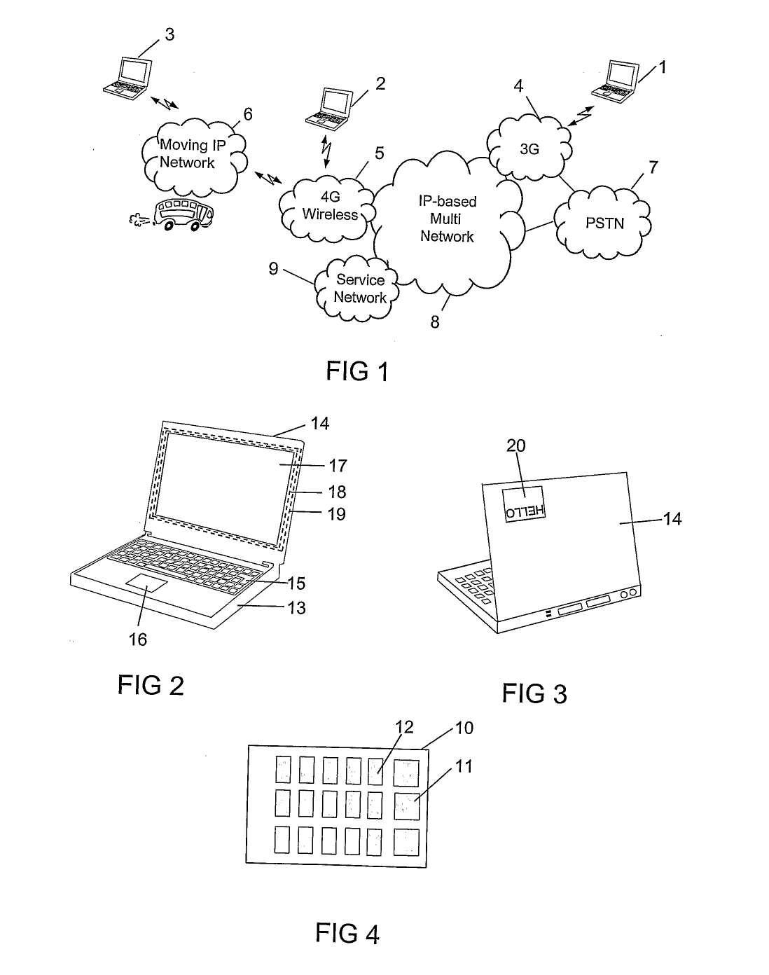

Preferred embodiments of the present invention and its advantages are best understood by referring to FIGS. 1-5 of the drawings; like numerals being used for like and corresponding parts of the various drawings.

FIG. 1 illustrates the environment in which the invention is used. Portable computers 1-3 provided with integrated WAN modules of the invention have each radio access to a WAN network. As an example of a WAN there is shown a 3G network 4, a xG wireless network 5, and a moving IP network 6. So called “hot spots” which are interconnected by a network may also be seen as a WAN. A “hot spot” is for example a radio access point to Internet at an airport. In accordance with the terminology used in this specification a WAN network is a cellular mobile network.

A WAN may use different technologies such as WCDMA (Wide-band Code Division Multiple Access), CDMA 2000 (Code Division Multiple Access), and EDGE (Enhanced Data rate for GSM Evolution) all of which comply with the 3G standard UMTS (Universal Mobile Telecommunications System). Other examples of WAN technologies are possible and the examples given is a non-exhaustive list. For example 1G and 2G standard technologies such as GSM (Global Services for Mobile transmissions), TDMA (Time Division Multiple Access), CDMA One, and PDC (Pacific Digital Cellular) or future network technologies (xG) may be used.

A WAN network may be connected to non-WAN networks such as for example PSTN (Public Switched Telephone Network) 7 and an IP (Internet Protocol suite) based multi network 8. The IP based multi network may in turn be connected to a service network 9. A WAN network may also be connected to another WAN network. The moving IP network, which may reside on board a train or a bus, is for example connected to the xG wireless network.

FIGS. 2, 3 and 4 illustrate a portable computer 2 with integrated WAN module in accordance with the invention. The portable computer comprises a motherboard 10, shown in FIG. 3, on which a number of IC circuits are mounted, among these a conventional processor 1 and an inventive WAN module 12. For the invention to operate it is not required that the WAN module sits on the motherboard. The WAN module may sit on other component cards, for example a video card, a sound card. The WAN module may even be provided on a card of its own.

The portable computer comprises a base casing 13 and a lid casing 14 pivotally mounted to the casing with non-shown hinges. The casing houses conventional units such as a hard disk, a CD (Compact Disc) reader/recorder, video card and a power unit for connection of the portable computer to the mains. A keyboard 15 and a pointing device 16 are mounted on top of the casing. The lid casing has on its side facing the keyboard a conventional display 17. Within the lid casing there is a WAN radio network module antenna 18 providing access to the WAN, and an FM radio antenna 19. Depending on the functions supported by the WAN module there may be other antennas as well, such as for example a GPS (Global Positioning System) antenna. The antennas may be of conventional design. Usually a WAN antenna is an array antenna while an FM radio antenna is a dipole. Other antenna designs may occur. In FIG. 2 the antennas are shown as rectangles which symbolize that the there is plenty of room available for antennas in the lid casing, allowing for non-conventional WAN antenna designs, among these three dimensional (3D) antenna designs.

In accordance with the invention the portable computer is provided with an extra display 20 connected to the WAN module. In the illustrated embodiment the extra display is located in the lid casing on the side that is visible when the lid is closed, that is the side opposite the display 17, thus being visible to the user when the portable computer lid is closed. Other locations are possible depending on portable computer design and extra display design. For example the extra display can be located on the same side as the display 17, beside the display 17 or even on top of it. The extra display may also be located on the keyboard side of the casing or even on the base casing side opposite the keyboard side. The extra display may even be a part of the display 17, for example a part located in the upper left corner. When the portable computer is in its sleeping mode the display 17 is grey (non-activated) and the low power consuming extra display is active and displays text and or video.

Instead of incorporating the WAN module in a portable computer it can be incorporated in a personal digital assistant (PGA), in a notebook computer or in any other type of a handheld computer that is portable and is provided with a battery.

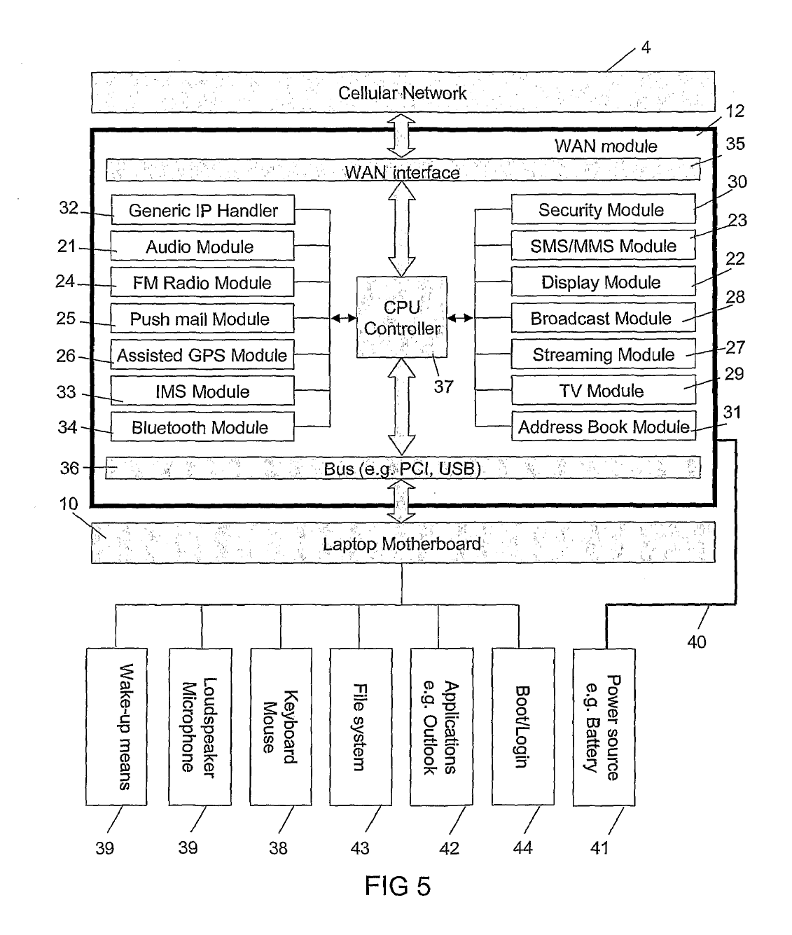

FIG. 5 illustrates a preferred embodiment of a WAN module. The WAN module is a modified cell phone platform comprising the following modules: an audio module 21, an extra display module 22, an SMS/MMS module 23, an FM radio module 24, a push mail module 25, an assisted GPS module 26, a streaming module 27, a broadcast module 28, a TV module 29, a security module 30, an address book module 31, a generic IP handler module 32, an IMS (IP Multimedia Subsystems) module 33, and a blue tooth module 34. There is further a WAN interface 35, a bus 36, and a CPU controller 37. The portable computer has a number of conventional peripheral units, among these a keyboard mouse 38, a loudspeaker and a microphone, the latter illustrated by rectangle 39. Further, the integrated unit comprises connection means 40 adapted to connect the WAN module to a battery 41 of the portable computer so as to supply power to the WAN module. The portable computer also software units such as applications 42, a file system 43, boot/log-in scripts 44, and means 45 adapted to wake up the computer.

Each module 21-34 communicates with the Wan interface via the CPU (Central Processing Unit) controller. Each module has an application program interface API that allows communication between the modules and the WAN interface. A socket is a “door” or “port” to the application or process in the module. Through this door packets (UDP (User Datagram Protocol), TCP (Transmission Control Protocol) or IP) marked with the corresponding port number are allowed to pass. The WAN interface directs arriving packets to their respective ports.

The WAN interface is the unit that accesses the WAN and comprises conventional, non-shown, cell phone platform devices for providing voice and data calls over the WAN. Examples of such devices are transceivers (TX/RX), modulators/demodulators, voice coders/decoders, filters and antenna circuits. Since the WAN interface receives/transmits packets of different formats, such as packets pertaining to the WAN and the Internet respectively and the received/transmitted packets are associated with different processes and applications, the WAN interface comprises a demultiplexing/multiplexing functionality provided by the IP protocol. The task performed by the demultiplexing functionality is to analyse the header of an incoming packet and, depending on the ID-tag therein, direct the packet to the correct port, also referred to as socket, associated with the process/application. Outgoing packets originating from different sources in the WAN module and the portable computer respectively are multiplexed by the WAN interface and transmitted over the air interface. Upon power up the WAN module registers its presence in the WAN over a radio connection with a nearby WAN base station in conventional manner and it listens to various control channels of the WAN.

The WAN module user has, like a mobile telephone user, an identity given by a SIM (Subscriber Identity Module) card with which an IMSI (International Mobile Subscriber Identity) number and a subscription is associated. The WAN module listens continuously to a paging of the WAN. If a broadcasted page contains the IMSI number associated with the illustrated WAN module, the WAN interface identifies the page as being directed to the WAN module and in response notifies the user either visually by a message on the extra display or by audio or a combination thereof.

In response to the reception of the page the WAN module also wakes up the portable computer if it was in sleeping mode, thereby providing access to the files on its hard disc or access to the server to which the portable computer is connected. For the wake-up procedure the WAN interface uses the WAN network processes which already are defined in the WAN network protocol. The control signal for wake-up of a mobile telephone is in this case used for wake up of the portable computer. Computer wake-up in response to a page is implemented by the use of the CPU controller and software.

The CPU controller is adapted to orchestrate selected interactions between selected ones of the functional modules 21-34 and selected ones of the peripheral devices 38-40. Functional modules and peripheral devices between which interaction shall take place depend on the implementation of the integrated WAN module and portable computer. The interactions that shall take place may be coded in the module or the CPU controller and as a general rule the user has the option to select the peripheral to be used for an individual functional module.

All functional modules comprise hardware, software and drivers required for implementing its individual functionality.

The audio module provides audio to the WAN module, such as audio to ear or head phones, and to external speakers. Audio from the WAN audio module may be combined with or be replaced by audio from the portable computer. This is done by a script that instructs the CPU controller to connect the audio module with the computer's audio system via the bus 36 and a non-shown bus on the motherboard.

The audio module comprises a music player, such as an MP3 player. Other music players may be provided in the audio module. Even a media player may be provided in the audio module. The extra display may show the title and artist of the currently played music. The audio module plays out audio from other WAN modules, such as the TV module, the streaming module, the broadcast module, the FM radio module, the GPS module, the SMS/MMS module, the IMS module and others.

The display module is used to drive the extra display so that it displays text, graphics, pictures, movies and video from other WAN modules such as the TV module, the FM radio module, the GPS module, the streaming module, the SMS/MMS module, the IMS module and others. The display module comprises a media player. Similar to the audio module text, graphics, movies coming from any of the WAN modules may be displayed on the computer's display instead of or as a complement to the extra display. This is done by a script that instructs the CPU controller to connect the display module with the computer's display system via the bus 36 and a non-shown bus on the motherboard.

The SMS/MMS module uses the WAN and receives therefrom SMS and MMS messages. Notifications of received messages are shown on the extra display and or in combination with audible beeps. It also interacts with the push mail module to be described below.

The FM radio module receives radio programs transmitted over the air and received on the FM antenna. It inter-works with the audio module, thus providing the radio service to the user without involving the portable computer. It also inter-works with the extra display to display the channel on which the user listens. Text advertisements transmitted together with the channel information are also displayed. The user may opt to use the audio system of the portable computer to play out the received audio.

The TV module is used for reception of TV programs transmitted over the air. The TV technique used is for example DVB-H (Digital Video Broadcast-Handhelds). The received TV program is shown on the extra display and sound is played over the audio module. Optionally the user may use the portable computer's audio and display when viewing the TV program. The TV module interacts with the display module via the CPU controller.

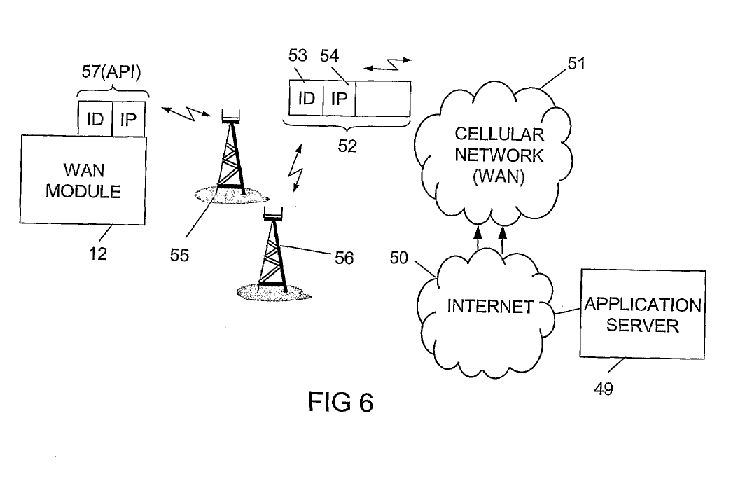

The push mail module will be explained in connection with FIG. 6 that illustrates an application server 49, for example a push mail server, Internet 50, a cellular network 51, a packet 52 with an ID field 53 and an IP field 54, base stations (BS) 55, 56, the WAN module 12 and a WAN module socket 57.

The first time a WAN identifies a cell phone or a WAN module the network identifies the individual cell phone/WAN module by the International mobile subscriber identification (IMSI) stored on the SIM card of the cellular phone/WAN module. When the module registers its presence in the network, the WAN network assigns to the WAN module a temporary ID.

The ID field contains the temporary ID. The ID is used by the network to keep a record of the mobile units within the network. This ID is communicated to the base stations. The base stations keep a list of the IDs communicated to them and can use the ID to address a mobile unit/WAN module.

The IP field contains an IP address. A mobile operator assigns the identified WAN module an IP address (through a PDP-context procedure). Explained in a simple and non-complete manner, the WAN module's IP address is mapped to the WAN module's ID. The IP address is, unlike the ID, used by routers in the Internet and other nodes in the WAN network to direct a packet to its destination. Each base station keeps a list of the identities ID and IP addresses of the WAN modules it serves.

All messages directed to the WAN module contains a reference to a port number associated with the application that processes the message, in this case the port number of the push module.

### Example 1

### Reception of a Push Mail

1. The application server sends the mail over Internet. Internet uses the IP address forwards the mail to WAN network using the IP address. The mail arrives to the WAN and the WAN needs to know the base station currently serving the WAN unit.
2. The WAN therefore requests the WAN module to update its current cell area location by transmitting a paging message on its broadcast channel, the paging message containing the ID of the WAN module.
3. The WAN module can be in either one of the following three modes:
A. Detached; the WAN module is off and cannot be detected by the WAN. The push mail is retained by the WAN. At a later instant the WAN module is paged again.
B. Idle/standby; On reception of the paging message the WAN module transits to its active mode, like an ordinary cellular phone does when it receives a call, and replies to the paging message. Now the WAN knows the position of the WAN module in the network and
C. Active; The WAN network detects the WAN module as in B above and the base station serving the module reserves communication resources to the module.
   4. The WAN transmits the mail to the WAN module.
   5. The IP packet is delivered to the WAN module's physical layer.
   6. The WAN module's push mail module listens for “push mail” packets via its application port number. Since the packets received by WAN module contain the corresponding port number, the push-module “opens its door” for such packets.
As to messages directed to the generic IP handler and to light version application modules built into the WAN module 12, see below.
   7. The push mail is stored temporary in a non-shown flash memory in the push mail module. The arrival of the mail is announced to the user, for example by a sound signal in combination with a text message presented on the extra display.
   8. The user may optionally wake up the portable computer manually or trigger the wake up means in order to synchronize the stored push mail with the file system of the e-mail application running on the portable computer. To do so the user activates the wake-up means.

When the wake up means is activated the portable computer should be waked up. To wake up the computer the boot/log in script is run. The wake up means will thus interact with the boot/log in script in order to wake up the portable computer.

The connection means adapted to connect the WAN module to the computer's battery may be embodied in many ways, such as a paths printed on circuit cards and card connector means. In FIG. 5 a wire is shown.

The assisted GPS module receives GPS signals via a non-shown antenna system provided within the lid of the personal computer. The GPS module displays positional information on the extra display and may provides audible information. As an example the GPS module may use the extra display to display a city map for navigation, and use the audio module transition point provide guide directions such as “turn to the right after 25 meters”. Optionally the user may select to use the computer's display and audio system.

The streaming module interacts with the WAN to receive streaming music and/or streaming movies. Audio is heard in real time over the audio module and video is seen in real time on the extra display. The user may opt to use the computer's audio system and display to play out a streaming movie. Likewise, the user may opt to play out streaming music over the computer's audio system. As is well known streaming music and movies cannot be stored on the computer, once it has been received by the WAN module, it is consumed.

The generic IP handler module may also be used to download contents from a content provider, such as for example MP3 music and movies. Down loaded content is stored on a non-shown memory card or is stored on the portable computer's hard disc. To this end the generic IP handler module inter-acts with the portable computer via the bus and under supervision from the CPU controller. Downloaded content is stored in the portable computer's file system.

The broad cast module makes it possible for the user to share music and video content with other users using a multi-cast or broad cast technique, such as MBMS (multimedia broadcast multicast services). To this end the broad cast module inter-acts with the computer via the bus and under supervision from the CPU controller.

The TV module is similar to the FM radio module and allows reception of TV programs over the air. The TV program is shown on the extra display together with the channel number. Audio is via the audio module. The user has the option to use the computer's display and audio.

The security module interacts with the SIM card in order to authenticate the WAN module to an entity, a service or an application on the Internet, typically in connection with a purchase over Internet. To applicant's knowledge this is not possible to-day. Any known authentication method may be used.

The address book module acts like a general telephone or address directory common to all applications and modules in the WAN module and in the personal computer, irrespective of the method used for the communication. Examples of communication methods and address types supported by the general telephone or address directory are e-mail, voice, instant messaging as well as usual telephone, fax and regular post addresses. Different applications will thus use one and the same directory. As an example, to-day Microsoft Outlook uses its own directory with telephone and fax numbers as well as e-mail addresses, while Microsoft Messenger has an address book of its own. Companies too have their own directories. All such separate directories are to be replaced with applicant's address book module.

The generic IP handler module takes incoming packets and analyses their heads to find out to the port, that is the application or process, with which the packet is associated. If the packet is associated with any of the modules of the WAN module the packet is directed to the corresponding module. If the packet is not associated with any of said modules, the generic IP handler sends the packet to the portable computer and the computer analyses the packet header in order to see if it matches any of the applications installed on the computer. If there is a match the computer signals this to the generic IP handler and the packet is forwarded to the computer. The packet is stored in a buffer during the analyses. If there is no match the packet is discarded.

As an alternative to, or in addition to the generic IP handler, the WAN module is provided with an operative system and with mini versions of popular applications such as MS Word and MS Outlook, said mini versions being able to identify a corresponding packet and either temporarily store it until a the complete message or file has been received, at which time the mini version transmits the message/file to the computer, or to synchronize the message with the corresponding application in the portable computer.

The IMS module gives access to a plurality of services in the WAN, such as for example “IMS weShare” and “push-to-talk” (PTT). “IMS weShare” is a mobile service that that provides users with a richer communication experience by combining voice calls with instant sharing of video clips, pictures or other contents. The PTT service allows a group of users to share a single channel. A user “is given the floor”, which means he/she gets authorization to speak, to send a text or to send a picture on the channel while the others in the group are listening/looking to the same channel. It is a kind of a walkie-talkie session.

The Bluetooth module is a low power, short-range, RF (Radio Frequency) technology that allows the connection of intelligent devices or appliances in a household or an office in a short-range wireless network. Examples of Bluetooth applications are transferring data between cell phones, radios, pagers, personal digital assistants, notebook computers and local area networks. The Bluetooth module allows short range communication between the integrated computer and WAN module and a user peripheral unit, such as an earphone. Suppose the WAN module is “on” and its user is working on the computer while he/she simultaneously is involved in a voice call. Suddenly the user has to leave the room wherein he/she is working. He/She therefore shuts down the computer, but the voice call continues over the WAN module's WAN interface while the user walks away.

The CPU controller is adapted to connect the portable computers keyboard with the extra display and selected ones of the modules within the WAN module so as to allow for displaying text entered at the keyboard. For example, text so entered and displayed are orders to the WAN module 12 or orders to the portable computer.

The audio module may comprises a non shown music player that inter-works with the audio module. The non shown music player, for example an MP3 player, is typically a client, an application or software. It will thus be possible to listen to music on the WAN module without involving the computer. Music may either be streamed to the WAN module in which case the streaming module is involved or downloaded to the WAN module in which case the generic IP handler is involved. The CPU controller coordinates the interaction between the music player, the audio module and the streaming module. The music player can also play downloaded music stored in a non-shown flash memory in the WAN module. Music stored in the file system on the computer may of course also be played on the music player in the WAN module.

### Example 2

### Downloading of an MP3 Melody

In this example the user of the WAN module sends a down load request to the application server shown in FIG. 6. The request is transmitted in an IP packet format and the packet header indicates as receiver a port number of the application server.

Thereafter the downloaded MP3 packets will follow the same sequence 1-8 as in Example 1.

The WAN unit, being a modified cell phone platform, may optionally be used as a mobile cell phone.

1. An integrated portable computer and WAN module, wherein the WAN module is a cell phone platform provided with a plurality of functional modules, characterized in that the WAN module is connected to a battery of the portable computer so as to supply power to the WAN module and allow operation of the functional modules while the portable is in operating mode as well as in sleeping mode.

2. The integrated portable computer and WAN module in accordance with claim 1, characterized in that the WAN module is provided with a WAN interface allowing radio based communication with WAN networks and networks connected to the WAN networks, and allowing communication with the functional modules using socket programmed functional modules.

3. The integrated portable computer and WAN module in accordance with claim 2, wherein the WAN module comprises a controller characterized in that the controller is adapted to orchestrate selected interactions between selected functional modules.

4. The integrated portable computer and WAN module in accordance with claim 3, wherein the portable computer comprises a number of peripheral devices, characterized in that the controller is adapted to orchestrate interactions between selected functional modules and selected peripherals.

5. The integrated portable computer and WAN module in accordance with claim 4, characterized in that the WAN module has access to a cellular mobile telephone network and its services.

6. The integrated portable computer and WAN module in accordance with claim 5, characterized in that the casing of the portable computer is provided with an extra display driven by a display module provided in the WAN module.

7. The integrated portable computer and WAN module in accordance with claim 6, characterized in that the display module interacts with a media player.

8. The integrated portable computer and WAN module in accordance with claim 7, characterized in that the WAN module comprises an audio module allowing play-out of audio.

9. The integrated portable computer and WAN module in accordance with claim 8, characterized in that the audio module interacts with a music player.

10. The integrated portable computer and WAN module in accordance with claim 9, characterized by the controller orchestrating interaction between the audio module, the display module and the WAN interface to allow for play out of audio on the audio module and presentation of text, picture and video information on the extra display, when a multi media communication takes place between the WAN and the WAN module.

11. The integrated portable computer and WAN module in accordance with claim 10, characterized in that the WAN module comprises a broadcast module allowing for sharing media content with other users over the WAN.

12. The integrated portable computer and WAN module in accordance with claim 11, characterized in that the portable computer casing is provided with antennas.

13. The integrated portable computer and WAN module in accordance with claim 12, characterized by the WAN module comprises an FM radio module allowing receipt of radio signals over the air.

14. The integrated portable computer and WAN module in accordance with claim 13, characterized by the WAN module comprises a TV module allowing receipt of television signals over the air.

15. The integrated portable computer and WAN module in accordance with claim 14, characterized in that the WAN module comprises an assisted GPS module.

16. The integrated portable computer and WAN module in accordance with claim 15, characterized in that the WAN module comprises a streaming media module for receiving streaming media over the WAN.

17. The integrated portable computer and WAN module in accordance with claim 16, characterized in that the WAN module comprises a media download module for download of media contents.

18. The integrated portable computer and WAN module in accordance with claim 17, characterized in that the WAN module comprises an IMS module allowing a “we Share” service and a PTT service.

19. The integrated portable computer and WAN module in accordance with claim 18, characterized in that the WAN module comprises an SMS/MMS module.

20. The integrated portable computer and WAN module in accordance with claim 19, characterized in that the WAN module comprises a security module adapted for authentication of the user of the integrated computer and WAN module in connection with payments, the authentication process using a PIN code associated with the user.

21. The integrated portable computer and WAN module in accordance with claim 20, characterized in that the WAN module comprises a generic IP handler module adapted to analyse the port number provided in the header of an incoming packet to the WAN module and to direct the packet to its associated functional module in the WAN module if there is a match between the port number and an API of the functional module,

22. The integrated portable computer and WAN module in accordance with claim 21, characterized in that the generic IP handler module is adapted to redirect the packet to the portable computer in case there is no match between the port number and an API of any of the functional modules,

23. The integrated portable computer and WAN module in accordance with claim 22, characterized in that the WAN module comprises a push mail module for reception of a “pushed” message transmitted over radio in the cellular network and addressed to the WAN module.

24. The integrated portable computer and WAN module in accordance with claim 23, characterized in that the “pushed” message is an SMS/MMS message or an e-mail.

25. The integrated portable computer and WAN module in accordance with claim 24, characterized in that the push mail module comprises wake up means adapted to wake up the WAN module in response to reception of a paging message over the WAN.

26. The integrated portable computer and WAN module in accordance with claim 25, characterized in that the portable computer is provided with wake up means adapted to interact with boot/log in scripts provided in the portable computer.

27. The integrated portable computer and WAN module in accordance with claim 26, characterized in that the controller orchestrates interworking between a functional unit and a file system in the portable computer.

28. The integrated portable computer and WAN module in accordance with claim 27, characterized in that that the controller is adapted to synchronize e-mail with an e-mail application.

29. The integrated portable computer and WAN module in accordance with claim 28, characterized in that the controller is connected to the SMS/MMS module and the push mail module, thereby allowing a user to compose SMS and e-mail messages on a keyboard of the portable computer.

30. The integrated portable computer and WAN module in accordance with claim 29, characterized in that the WAN module comprises a general address book that further to names, addresses, telephone numbers, mobile telephone numbers, fax numbers and e-mail addresses comprise instant messaging addresses.

31. The integrated portable computer and WAN module in accordance with claim 30, characterized in that the WAN module comprises a Bluetooth module allowing short range communication between the integrated computer and WAN module and a user peripheral unit.

32. The integrated portable computer and WAN module in accordance with claim 31, wherein the portable computer comprises loudspeaker characterized by means adapted to connect the audio module with the loudspeaker, thereby allowing optional play-out of audio from the audio module over the portable's loudspeaker.

33. The integrated portable computer and WAN module in accordance with claim 32, wherein the portable computer comprises a display, characterized by means adapted to connect the display module with a display on the portable computer, thereby allowing optional play-out of text and video from the display module over the portable's display and loudspeaker.
